(19) United States
(12) Patent Application Publication
(10) Pub. No.: US 2012/0274214 A1
(43) Pub. Date: Nov. 1, 2012

(54) LIGHTING DEVICE WITH COOLING ARRANGEMENT

(75) Inventors: Harald Josef Günther Radermacher, Aachen (DE); Matthias Wendt, Wurselen (DE)

(73) Assignee: KONINKLIJKE PHILIPS ELECTRONICS N.V., EINDHOVEN (NL)

(21) Appl. No.: 13/321,833

(22) PCT Filed: May 19, 2010
(86) PCT No.: PCT/IB10/52220

§ 371 Date: Feb. 3, 2012

(30) Foreign Application Priority Data
May 26, 2009 (EP) 09161048.5

(51) Int. Cl. H01J 7/24

(52) U.S. Cl. 315/113; 315/112

(57) ABSTRACT

In a lighting device (100) comprising an AC light source (14) and a cooling arrangement (52, 62) and a coil (11) for producing a magnetic field for driving the arrangement (52, 62), the coil (11) is serially coupled to the AC light source (14) for making the lighting device (100) more compact. The arrangement (52, 62) comprises a moveable part for displacing a quantity of air or another gas or a fluid. Preferably, the lighting device (100) comprises a further coil (21) for producing a further magnetic field for further driving the arrangement (52, 62), and a phase-shift is introduced between currents flowing through the coil (11) and the further coil (21). The AC light source (14) comprises a combination of a rectifier and a light emitting diode and/or comprises a combination of at least two light emitting diodes combined in an anti-parallel manner.

### FIELD OF THE INVENTION

The invention relates to a lighting device. The invention also relates to a method for cooling such a lighting device. Examples of such a lighting device are lamps.

### BACKGROUND OF THE INVENTION

US 2007/0147046 discloses a light emitting diode light with active cooling. Thereto, a power control module provides a first voltage to a flexible blade and provides a second voltage to a light emitting diode. In response to the first voltage, the flexible blade starts oscillating. The first voltage is an alternating-current voltage. The second voltage is a direct-current voltage or a relatively small alternating-current voltage different from the first voltage.

### SUMMARY OF THE INVENTION

Objects of the invention are to provide a relatively compact lighting device and to provide a method for cooling a relatively compact lighting device.

According to a first aspect of the invention, a lighting device is provided comprising
an alternating-current light source,
an arrangement for cooling at least a part of the alternating-current light source, and
a coil for producing a magnetic field for driving the arrangement, the coil being serially coupled to the alternating-current light source.

By having introduced an alternating-current light source, in other words a light source that is to be fed with an alternating-current voltage, a coil for producing a magnetic field for driving a cooling arrangement can be serially coupled to the alternating-current light source. As a result, a disadvantageous power control module is avoided, and the lighting device can be more compact.

Further advantages are that, when the power control module is avoided, the lighting device can be produced at lower costs and can be more robust/reliable.

According to an embodiment, the lighting device is defined by the arrangement comprising a moveable part, and said driving comprising moving said moveable part for displacing a quantity of air or another gas or a fluid. Thereto, a spring or springy means may be used to bring the moveable part in a neutral position, and the magnetic field may be used to bring the moveable part in one or more non-neutral positions located at one or more sides of the neutral position.

According to an embodiment, the lighting device is defined by further comprising
a further coil for producing a further magnetic field for further driving the arrangement, the coil and the alternating-current light source forming part of a first branch, the further coil forming part of a second branch, the first and second branches being parallel branches.

Two coils in two parallel branches will increase a number of options for driving the cooling arrangement.

According to an embodiment, the lighting device is defined by at least one of the first and second branches comprising an element for introducing and/or increasing a phase-shift between first and second currents flowing through the first and second branches. Phase-shifted currents in the branches will result in phase-shifted magnetic fields produced by the coils. The element may be a passive element such as a capacitor. Alternatively, the element may partly or entirely form part of one of the coils, and/or the coils may be given different dimensions and/or may be of different types and/or may have different values such that the coils introduce and/or increase the phase-shift or a part thereof etc.

According to an embodiment, the lighting device is defined by said further driving comprising further moving said moveable part, said moving and said further moving comprising different movements. The phase-shifted magnetic fields will result in different movements of the moveable part.

According to an embodiment, the lighting device is defined by said different movements being different in time and/or in place. A first piece of the moveable part may be moved at a first moment in time and a second piece of the moveable part may be moved at a second moment in time, the first and second moments in time being different moments in time, and the first and second pieces being different pieces or equal pieces. A third piece of the moveable part at a first location may be moved and a fourth piece of the moveable part at a second location may be moved, the first and second locations being different locations. The moveable part may be flexible and then move via its flexibility or may be rigid and then move via a for example partial rotation or a vibration etc.

According to an embodiment, the lighting device is defined by further comprising
a further alternating-current light source forming part of the second branch and being serially coupled to the further coil.

Two alternating-current light sources fed with phase-shifted currents will together produce light that suffers less from flickering effects.

According to an embodiment, the lighting device is defined by further comprising
a terminal for receiving an alternating-current voltage, a first part of the alternating-current voltage being present across the alternating-current light source, a second part of the alternating-current voltage being present across the coil, the first and second parts being different parts.

According to an embodiment, the lighting device is defined by the alternating-current light source comprising a combination of a rectifier for converting the first part of the alternating-current voltage into a direct-current voltage and at least one light emitting diode fed with the direct-current voltage, or the alternating-current light source comprising a combination of at least two light emitting diodes combined in an anti-parallel manner. The rectifier may comprise a diode or two diodes or more diodes or a diode bridge and/or may comprise passive and/or active elements. The anti-parallel manner defines that at least one of the light emitting diodes forms part of a first connection and at least one other of the light emitting diodes forms part of a second connection, the first and second connections being parallel connections such that a first current will flow through the first connection in a first direction and a second current will flow through the second connection in a second direction, the first and second directions being opposite directions. Further passive and/or active elements in each connection are not to be excluded. Other alternating-current light sources are not to be excluded.

According to a second aspect of the invention, a method is provided for cooling a lighting device comprising an alternating-current light source, the method comprising steps of
via a coil that is serially coupled to the alternating-current light source, producing a magnetic field for driving an arrangement, and
via the arrangement, cooling at least a part of the alternating-current light source.

Embodiments of the method correspond with the embodiments of the lighting device.

An insight might be that a power control module is to be avoided. A basic idea might be that a lighting device is to be provided with an alternating-current light source and with a coil serially coupled to the alternating-current light source for producing a magnetic field for driving an arrangement for cooling at least a part of the alternating-current light source.

A problem to provide a relatively compact lighting device has been solved. Further advantages are that the lighting device can be produced at lower costs and can be more robust/reliable.

These and other aspects of the invention are apparent from and will be elucidated with reference to the embodiment(s) described hereinafter.

### BRIEF DESCRIPTION OF THE DRAWINGS

In the drawings:

FIG. 1 shows a first schematic embodiment of a lighting device,

FIG. 2 shows a second schematic embodiment of a lighting device,

FIG. 3 shows four current waveforms,

FIG. 4 shows a lighting device,

FIG. 5 shows a cross section of the lighting device,

FIG. 6 shows four operational states of the lighting device,

FIG. 7 shows a cross section of another lighting device,

FIG. 8 shows a third schematic embodiment of a lighting device, and

FIG. 9 shows a fourth schematic embodiment of a lighting device.

### DETAILED DESCRIPTION OF EMBODIMENTS

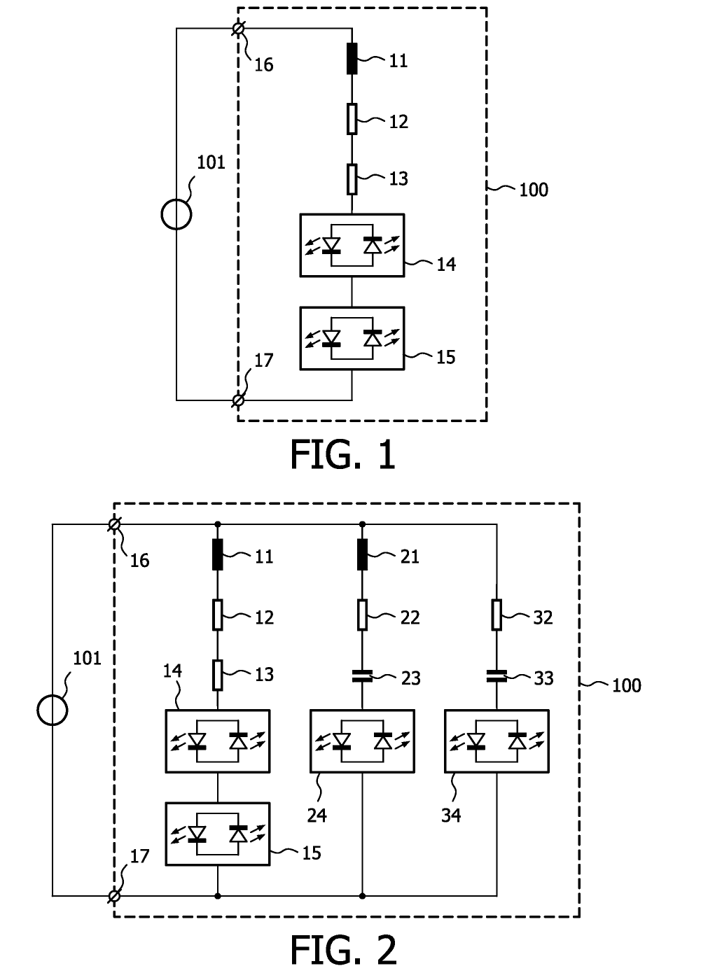

In the FIG. 1, a first schematic embodiment is shown of a lighting device 100. The lighting device 100 comprises terminals 16 and 17 to be coupled to an alternating-current voltage source 101 or AC voltage source 101. The terminals 16 and 17 are coupled to a first serial branch of a first coil 11, a resistor 12, a resistor 13, a first alternating-current light source 14 or AC light source 14, and a second alternating-current light source 15 or AC light source 15.

In the FIG. 2, a second schematic embodiment is shown of a lighting device 100. This second schematic embodiment differs from the first schematic embodiment in that in addition there are second and third serial branches coupled in parallel to each other and to the first serial branch. The second serial branch comprises a second coil 21, a resistor 22, a first capacitor 23, and a third alternating-current light source 24 or AC light source 24. The third serial branch comprises a resistor 32, a second capacitor 33, and a fourth alternating-current light source 34 or AC light source 34.

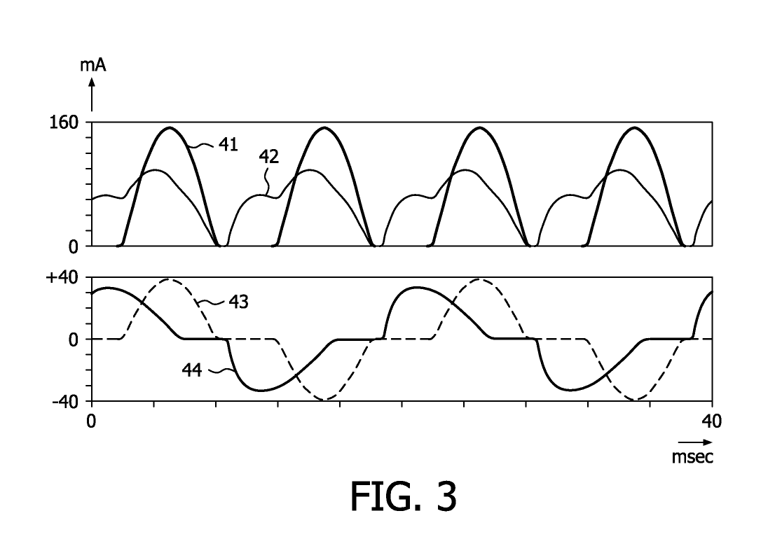

In the FIG. 3, four current waveforms are shown for the second schematic embodiment shown in the FIG. 2 in case the coils 11 and 21 are left out. The waveform 41 defines an absolute value of four times a current flowing through the resistor 12. The waveform 42 defines an absolute value of currents flowing through the resistors 12, 13, 22 and 32. The waveform 43 defines a current flowing through the resistor 12 (or 13). The waveform 44 defines a current flowing through the resistor 22 (or 32). Between the waveforms 43 and 44, clearly a phase-shift is present.

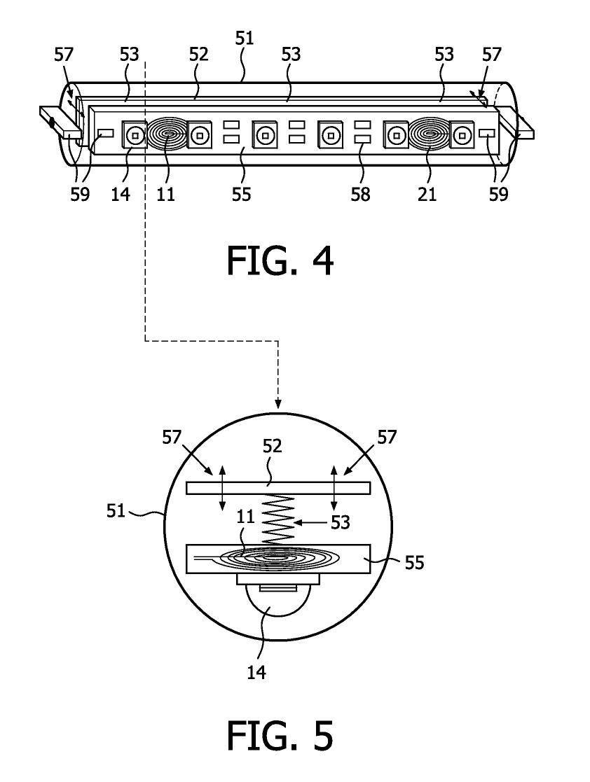

In the FIG. 4, a lighting device is shown and in the FIG. 5, its cross section is shown. The lighting device comprises a glass tube 51, an arrangement 52 for cooling at least a part of the lighting device and comprising a moveable part coupled to a spring 53, a heat sink 55 comprising the coils 11 and 21, alternatively these coils 11 and 21 may be located outside the heat sink 55, just like the AC light source 14. Further shown are ballast circuitry 58 such as the resistors 12, 13, 22 and 32 and/or the capacitors 23 and 33, contacts and end caps 59 such as the terminals 16 and 17, and a moving direction 57 of the arrangement 52. Preferably, the heat sink 55 is extended to the glass tube 51 for sealing purposes. Further preferably, the spring 53 and the mounting of the spring 53 to the heat sink 55 and the arrangement 52 is such that heat is conducted from the heat sink 55 through the spring 53 to the arrangement 52 to increase the effective area where heat can be exchanged with a cooling medium such as a quantity of air or another gas or a fluid.

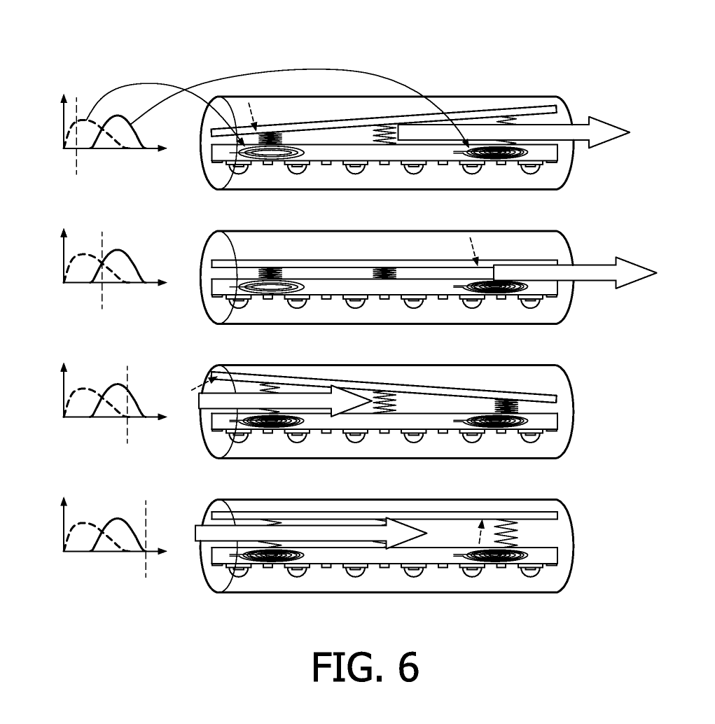

In the FIG. 6, four operational states of the lighting device are shown. From top to bottom, firstly only a left coil is activated, and a left side of the moveable part is moved towards the heat sink, and warm air is displaced to a right side. Secondly, the left coil and a right coil are both activated, and a right side of the moveable part is also moved towards the heat sink, and at the right side the warm air is pushed out. Thirdly, only the right coil is activated, and the left side of the moveable part is moved away from the heat sink, and at the left side cool air can enter. Fourthly, none of the coils is activated, and the right side of the moveable part is also moved away from the heat sink, and the cool air is displaced to the right while being warmed up etc. Clearly, the moveable part experiences different movements that are different in time as well as different in place.

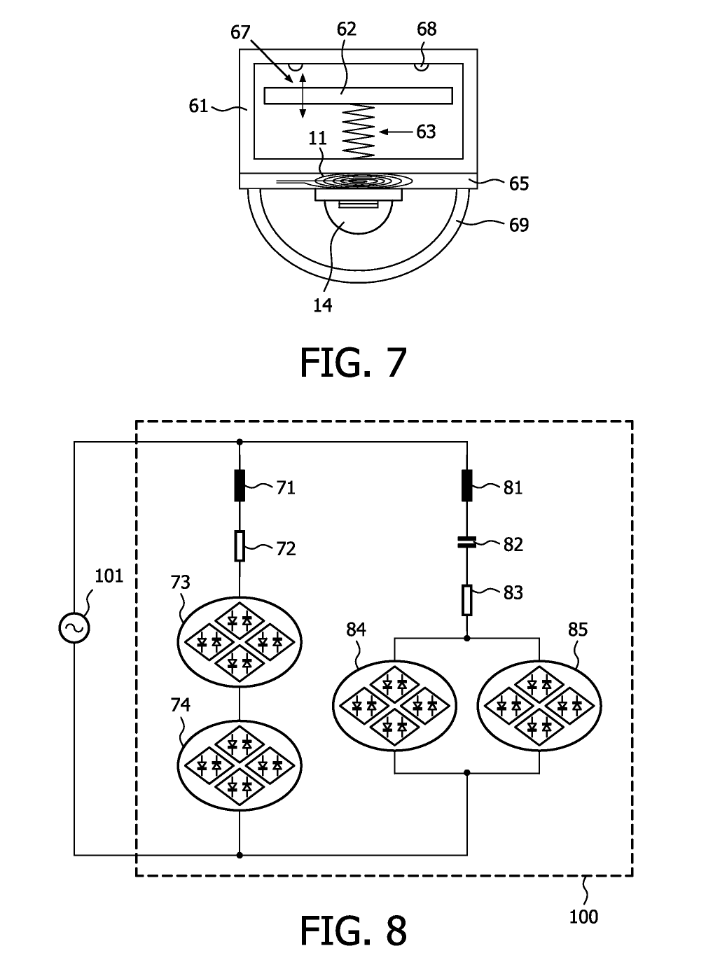

In the FIG. 7, a cross section is shown of another lighting device. The lighting device comprises a profile 61, an arrangement 62 for cooling at least a part of the lighting device and comprising a moveable part coupled to a spring 63, a printed circuit board or foil 65 comprising the coil 11, the AC light source 14 being mounted on this printed circuit board or foil 65. Further shown are an anti-stick spacer 68, a transparent cover 69, and a moving direction 67 of the arrangement 62. The profile 61 is for example a metal profile, such as an aluminum profile. Of course, the magnetic field coming from the coil 11 should be able to penetrate this profile 61.

In the FIG. 8, a third schematic embodiment is shown of a lighting device 100. The lighting device 100 comprises a first serial branch of a first coil 71, a resistor 72, an AC light source 73, and an AC light source 74. In parallel to the first serial branch, there is a second serial branch of a second coil 81, a resistor 82, a capacitor 83, and two AC light sources 84 and 85 coupled in parallel to each other. Each AC light source comprises several groups of anti-parallel light emitting diodes, which groups are, per AC light source, coupled serially and/or in parallel etc.

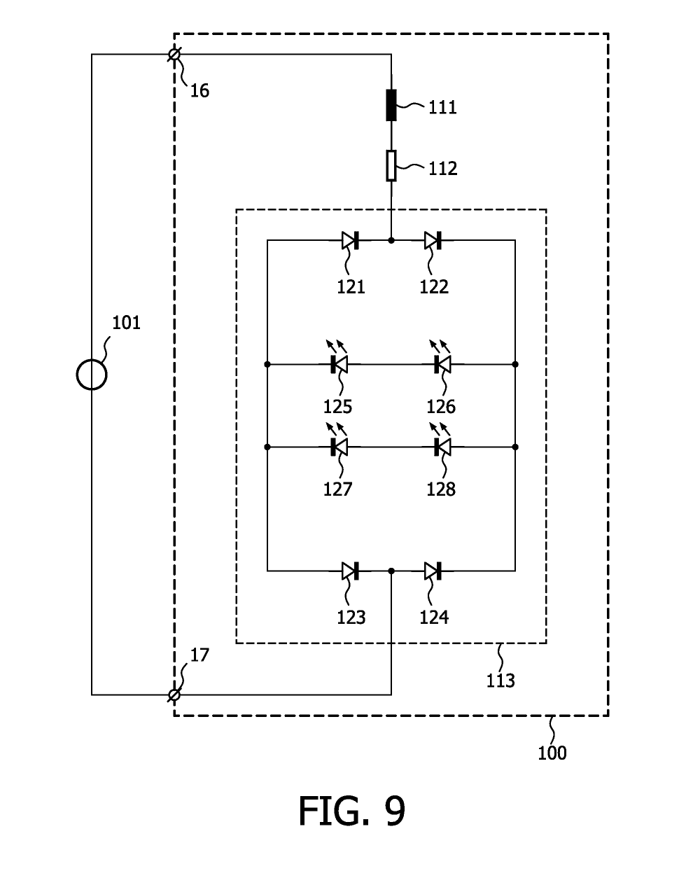

In the FIG. 9, a fourth schematic embodiment is shown of a lighting device 100. The lighting device 100 comprises a serial branch of a coil 111, a resistor 112, and an AC light source 113 that comprises four diodes 121-124 in a rectifier bridge and two parallel strings of light emitting diodes 125-128 coupled to a positive output and to a negative output of the rectifier bridge. Each string comprises two serial light emitting diodes. Alternatively, one string or three or more strings may be present. Further alternatively, each string may comprise an individual and arbitrary number of one or more light emitting diodes coupled serially and/or in parallel etc. Preferably, the total forward voltage of a serial connection in one of the strings is similar to the total forward voltage of another parallel string (if present) in order to have similar currents in the strings. Alternatively, a current distribution can be set to a certain ratio on purpose by selection the forward voltages of the strings and/or by adding current limiting elements (e.g. resistors). In a preferred embodiment of the FIG. 9, a capacitor is connected in parallel to the string(s). This capacitor will store some energy and release it to the light emitting diodes to smoothen the light generated by the AC light source. When combining the structure of the AC light source 113 with a multiple branch structure (as shown in the FIG. 2 or 8), the size of the capacitor(s) in parallel to the string(s) can be used to realize at least a part of the phase shift.

In a minimum situation, the lighting device 100 comprises the AC light source 14, the arrangement 52, 62 for cooling at least a part of the AC light source 14, and the coil 11 for producing the magnetic field for driving the arrangement 52, 62, which coil 11 is serially coupled to the alternating-current light source 14. In this case, the moveable part may be a flexible and/or resilient part that is moved out of a neutral position in response to the magnetic field and that is moved back into the neutral position as a consequence of being flexible and/or resilient. Alternatively, the moveable part may be a rigid part that is coupled to a spring or springy means and that is moved out of a neutral position in response to the magnetic field and that is moved back into the neutral position in response to a force coming from the spring or springy means.

In a more advanced situation, the lighting device 100 comprises a further coil 21 for producing a further magnetic field etc. and/or comprises an element 23 for introducing a phase-shift between first and second currents flowing through the first and second branches etc. and/or comprises a further AC light source 24 etc.

The moveable part may be made of iron (or at least containing some soft or hard magnetic material). When a current flows through one of the coils, the moveable part will be attracted by the coil. In case of normal iron, this attraction will be present regardless of the direction of the current. In case the moveable part is made from a hard magnetic material (permanent magnet) the moveable part would be attracted or repulsed, depending on the polarity of the current in the coil. Instead of making the moveable part from a permanent magnet, it would also be possible to apply this permanent magnet next to the coils to provide an “offset” for the magnetic field.

The moveable part, the moved air or gas or fluid and the springs make up a mechanical resonating system. The resonant frequency of this system has to be tuned to the frequency of excitation, which depends on the frequency of the AC voltage source 101 which might be the mains voltage and the magnetic structure (coil+iron would double the effective frequency while coil+permanent magnet wouldn't). For application in different countries with different mains frequencies, different lighting devices may be used. Alternatively, by influencing the quality of the resonating system, a broad band system excitable by different mains voltages can be built.

Summarizing, in a lighting device 100 comprising an AC light source 14 and a cooling arrangement 52, 62 and a coil 11 for producing a magnetic field for driving the arrangement 52, 62, the coil 11 is serially coupled to the AC light source 14 for making the lighting device 100 more compact. The arrangement 52, 62 comprises a moveable part for displacing a quantity of air or another gas or a fluid. Preferably, the lighting device 100 comprises a further coil 21 for producing a further magnetic field for further driving the arrangement 52, 62, and a phase-shift is introduced between currents flowing through the coil 11 and the further coil 21. The AC light source 14 comprises a combination of a rectifier and a light emitting diode and/or comprises a combination of at least two light emitting diodes combined in an anti-parallel manner.

While the invention has been illustrated and described in detail in the drawings and foregoing description, such illustration and description are to be considered illustrative or exemplary and not restrictive; the invention is not limited to the disclosed embodiments. For example, it is possible to operate the invention in an embodiment wherein different parts of the different disclosed embodiments are combined into a new embodiment.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. A lighting device comprising
an alternating-current light source,
a first arrangement for cooling at least a part of the alternating-current light source, and
a first coil for producing a first magnetic field for driving the arrangement, the coil being serially coupled to the alternating-current light source.

2. The lighting device as claimed in claim 1, wherein the first arrangement comprising a moveable part, and said driving comprising moving said moveable part for displacing a quantity of gas or fluid.

3. The lighting device as claimed in claim 2, further comprising
a second coil for producing a second magnetic field for further driving the arrangement, the coil and the alternating-current light source forming part of a first branch, the second coil forming part of a second branch, the first and second branches being parallel branches.

4. The lighting device as claimed in claim 3, at least one of the first and second branches comprising an element for introducing and/or increasing a phase-shift between first and second currents flowing through the first and second branches.

5. The lighting device as claimed in claim 4, said further driving comprising further moving said moveable part, said moving and said further moving comprising different movements.

6. The lighting device as claimed in claim 5, said different movements being different in time and/or in place.

7. The lighting device as claimed in claim 4, further comprising
a second alternating-current light source forming part of the second branch and being serially coupled to the second coil.

8. The lighting device as claimed in claim 1, further comprising
a terminal for receiving an alternating-current voltage, a first part of the alternating-current voltage being present across the alternating-current light source, a second part of the alternating-current voltage being present across the coil, the first and second parts being different parts.

9. The lighting device as claimed in claim 8, wherein the alternating-current light source comprises a combination of a rectifier for converting the first part of the alternating-current voltage into a direct-current voltage and at least one light emitting diode fed with the direct-current voltage, or the alternating-current light source comprising a combination of at least two light emitting diodes combined in an anti-parallel manner.

10. A method for cooling a lighting device comprising an alternating-current light source, the method comprising steps of
via a coil that is serially coupled to the alternating-current light source, producing a magnetic field for driving an arrangement, and
via the arrangement, cooling at least a part of the alternating-current light source.
